(19) United States
(12) Patent Application Publication
(10) Pub. No.: US 2018/0290285 A1
(43) Pub. Date: Oct. 11, 2018

(54) PNEUMATIC ANGLE GRINDER HAVING IMPROVED GRIP STRUCTURE

(71) Applicant: STORM PNEUMATIC TOOL CO., LTD., Taichung City (TW)

(72) Inventor: Yung Yung Sun, Taichung City 412 (TW)

(21) Appl. No.: 15/902,561

(22) Filed: Feb. 22, 2018

(30) Foreign Application Priority Data
Apr. 10, 2017 (TW) 106204897

(51) Int. Cl. B25F 5/02; B24B 23/02

(52) U.S. Cl. CPC B25F 5/02; B24B 23/026

(57) ABSTRACT

A pneumatic angle grinder having an improved grip structure to solve the problem that the holding posture is not ergonomic when the wrist is lifted. When a press handle is pressed downward to the bottommost, a rear section of the press handle is lower than a front section thereof. The rear section is substantially flush with a tail portion of a cover. A depression is formed above a bent section and the rear section of the press handle and the tail portion of the cover relative to the height of the front section. When an operator grasps a head portion of a main body, the thenar and the hypothenar of the operator lean against the cover. The location of the depression to rest the bottom side of the wrist is significantly lower than the top end of the head portion for the wrist to move downward.

### FIELD OF THE INVENTION

The present invention relates to a pneumatic angle grinder, and more particularly to a pneumatic angle grinder having an improved grip structure.

### BACKGROUND OF THE INVENTION

As shown in FIG. 5, a conventional pneumatic angle grinder has a main body 81 and a grinding device (such as a grinding wheel or buffing wheel) mounted to the bottom of the main body 81. The main body 81 has a head portion 82 on its top and a valve seat 83 extending from one side of the head portion 82. The valve seat 83 is provided with a connector 84 for inhaling and exhausting air. The valve seat 83 is provided with a switch 85. One end of a press handle 86 is pivotally connected to the valve seat 83. The press handle 86 extends beyond the switch 85. Another end of the press handle 86 is above the head portion 82.

When in use, the operator grasps the head portion 82 with his/her fingers, the thenar and the hypothenar of the operator are placed on the valve seat 83 to press the press handle 86 so as to start the switch 85, and the main body 81 is moved downward for grinding. However, the press handle 86 is a straight handle, which is in a horizontal state when pressed by the operator's hand. The horizontal press handle 86 is approximately equal to the height of the top end of the head portion 82. In this case, the thenar and the hypothenar of the operator are lifted on the press handle 86 and the wrist is lifted higher than the top end of the head portion 82. This posture is not ergonomic. After a long-time use, the hand is prone to ache or have other discomforts.

FIG. 6 illustrates another conventional pneumatic angle grinder, which is mainly different from the above pneumatic angle grinder in that a head portion 92 on the top of a main body 91 is provided with a cover 94 on a valve seat 93 extending laterally. The top surface of the cover 94 is slightly inclined rearward in a direction away from the head portion 92. The press handle 96 is also a straight handle. When in use, the operator grasps the head portion 92 with his/her fingers, the thenar and the hypothenar of the operator are placed on the valve seat 93 to lean against the cover 94 so as to press the press handle 96 and activate the switch 95 for grinding. Although the top surface of the cover 94 is slightly inclined rearward, and the press handle 96 is also inclined when pressed. The height difference between the inclination and the top end of the head portion 92 is not conspicuous. In particular, there is no significant height difference at the junction of the head portion 92 and the valve seat 93. When in use, the operator's thenar and hypothenar on the cover 94 may be lifted, and the bottom side of the wrist is lifted to a height higher than the top end of the head portion 92. This posture is not ergonomic. After a long-time use, the hand is prone to ache or have other discomforts. Accordingly, the inventor of the present invention has devoted himself based on his many years of practical experiences to solve these problems.

### SUMMARY OF THE INVENTION

The primary object of the present invention is to provide a pneumatic angle grinder having an improved grip structure. After a long-time use of the pneumatic angle grinder of the present invention, the operator's hand won't ache easily or have other discomforts.

In order to achieve the aforesaid object, the pneumatic angle grinder of the present invention comprises a main body. The main body has a passage therein for inhaling and exhausting air. High pressure air passes through the passage to drive an air motor to rotate so as to actuate a grinding device mounted to a bottom of the main body. The main body has a head portion at a top thereof and a valve seat extending from one side of the main body. The valve seat is provided with a connector for supplying air. The valve seat is provided with a switch for controlling rotation of the air motor. One end of a press handle is pivotally connected to the valve seat. The press handle extends beyond the switch. Another end of the press handle is above the head portion. A cover is pivotally connected to the valve seat. The cover has a side portion located on the valve seat to cover opposite sides of the press handle. The cover has a tail portion extending outward along the valve seat to cover the connector.

When the press handle is pressed downward to the bottommost, a portion of the press handle above the head portion is defined as a front section and another portion above the valve seat is defined as a rear section. A bent section is defined between the front section and the rear section. The bent section bends downward from the front section to the rear section. The rear section is connected to the tail portion and is substantially flush with the tail portion. A depression is formed above the bent section, the rear section and the tail portion relative to a height of the front section. When an operator grasps the head portion, the depression allows the thenar and the hypothenar of the operator to move downward and lean against the cover. The bent section is inclined. The side portion is formed with an engaging portion tilted upward corresponding to the inclination of the bent section. The cover includes a front cover and a rear cover. The front cover and the rear cover are separated. The side portion is disposed on the front cover. The tail portion is disposed on the rear cover. The rear cover of the cover is pivotally connected to a top surface of the valve seat so that the rear cover can be turned relative to the valve seat, and the front cover covers the valve seat.

### BRIEF DESCRIPTION OF THE DRAWINGS

FIG. 1 is a perspective view of the present invention;

FIG. 2 is an exploded view of FIG. 1;

FIG. 3 is a sectional view of FIG. 1;

FIG. 4 is a schematic view of the present invention when in use;

FIG. 5 is a schematic view of a conventional pneumatic angle grinder when in use; and

FIG. 6 is a schematic view of another conventional pneumatic angle grinder when in use.

### DETAILED DESCRIPTION OF THE PREFERRED EMBODIMENTS

Embodiments of the present invention will now be described, by way of example only, with reference to the accompanying drawings.

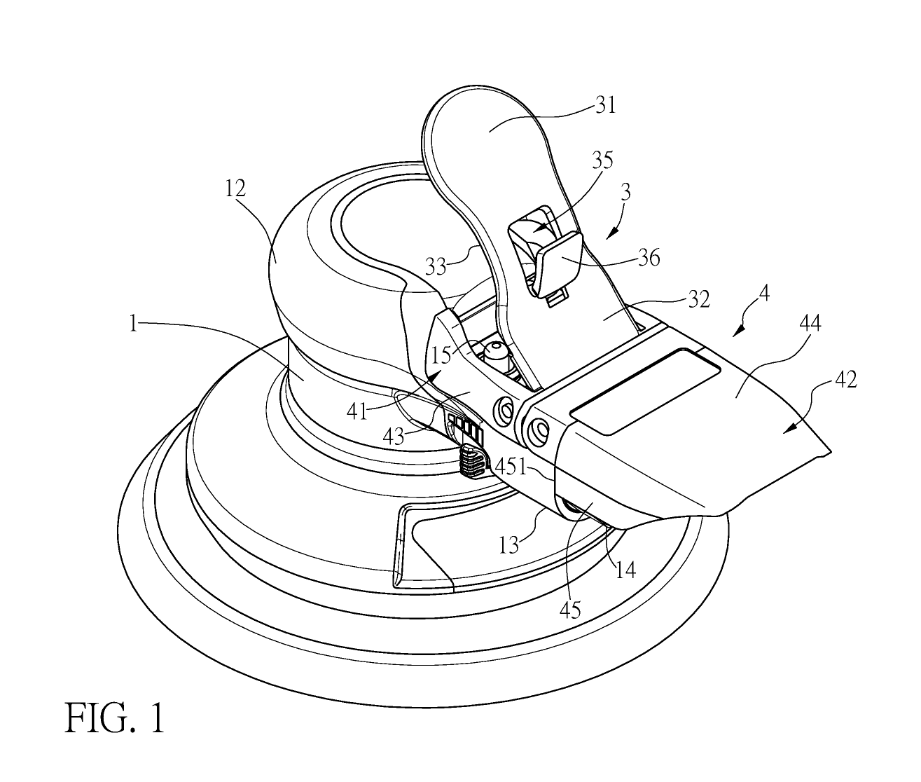

The present invention discloses a pneumatic angle grinder having an improved grip structure. As shown in FIGS. 1 to 3, the pneumatic angle grinder comprises a main body 1, an air motor 2, a press handle 3, and a cover 4.

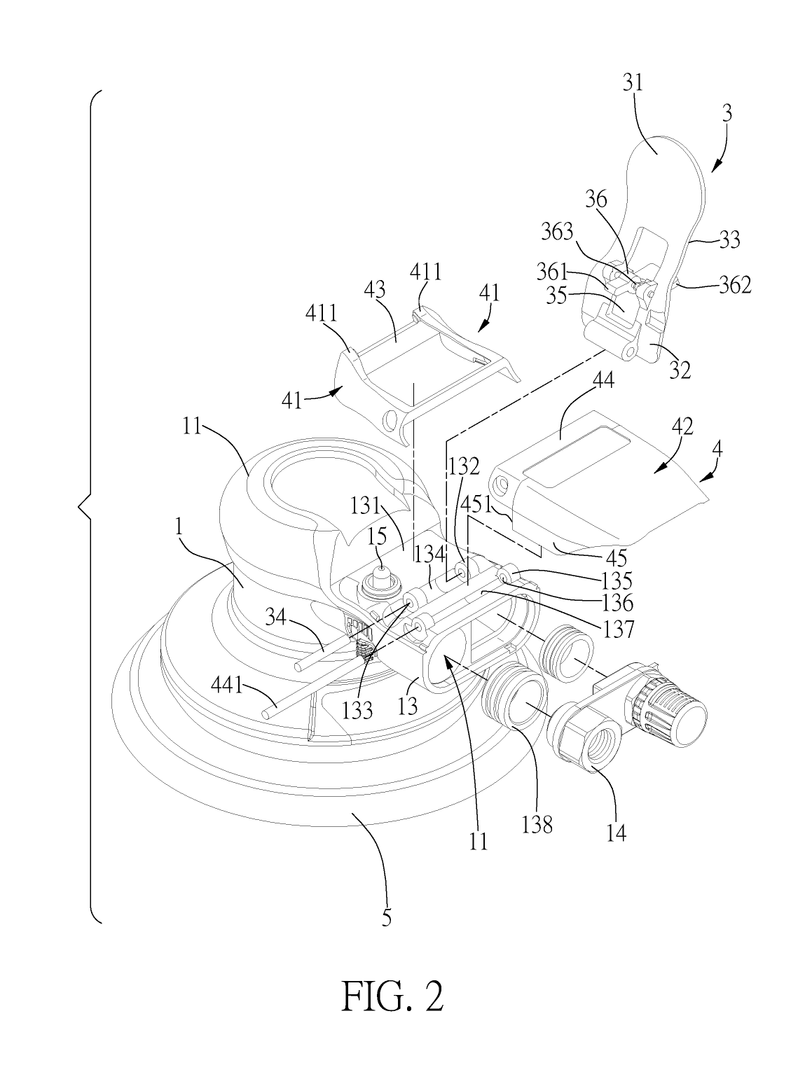

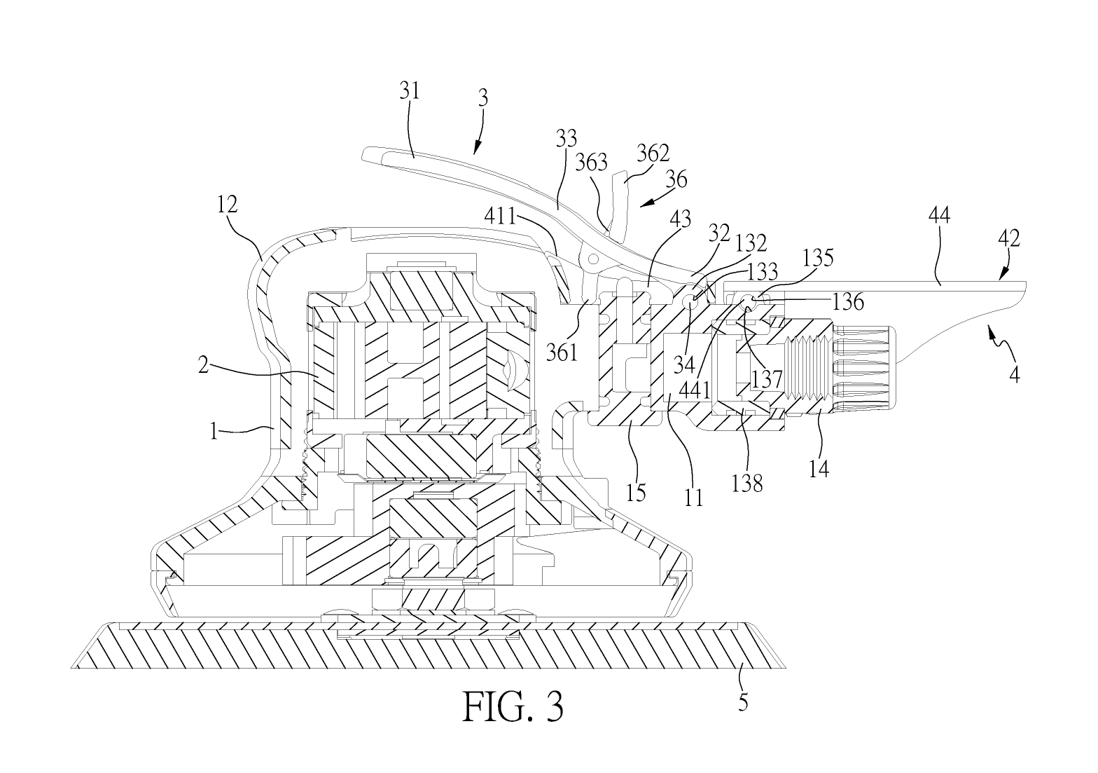

As shown in FIGS. 2 to 3, the main body 1 has a passage 11 therein for inhaling and exhausting air. High pressure air passes through the passage 11 to drive the air motor 2 to rotate so as to actuate a grinding device 5 mounted to the bottom of the main body 1. In this embodiment, the grinding device 5 may be a buffing wheel or a grinding wheel. The main body 1 has a head portion 12 at its top and a valve seat 13 extending from one side of the main body 1. The valve seat 13 is provided with a connector 14 for supplying air. The valve seat 13 is provided with a switch 15 for controlling the rotation of the air motor 2. One end of the press handle 3 is pivotally connected to the valve seat 13. The press handle 3 extends beyond the switch 15. Another end of the press handle 3 is above the head portion 12.

The cover 4 of the present invention is pivotally connected to the head portion 12 or the valve seat 13 and can be flipped relative to the valve seat 13. As shown in FIGS. 1 to 4, the cover 4 of the present invention has a side portion 41 and a tail portion 42. The side portion 41 is located on the valve seat 13 to cover opposite sides of the press handle 3. The tail portion 42 extends outward along the valve seat 13 to cover the connector 14. The cover 4 is pivotally connected to the valve seat 13. Thereby, the operator can hold the head portion 12 with his/her hand and press the press handle 3 downward to touch the switch 15, so that the air motor 2 is driven to rotate by inputting the high-pressure air to activate the grinding device 5.

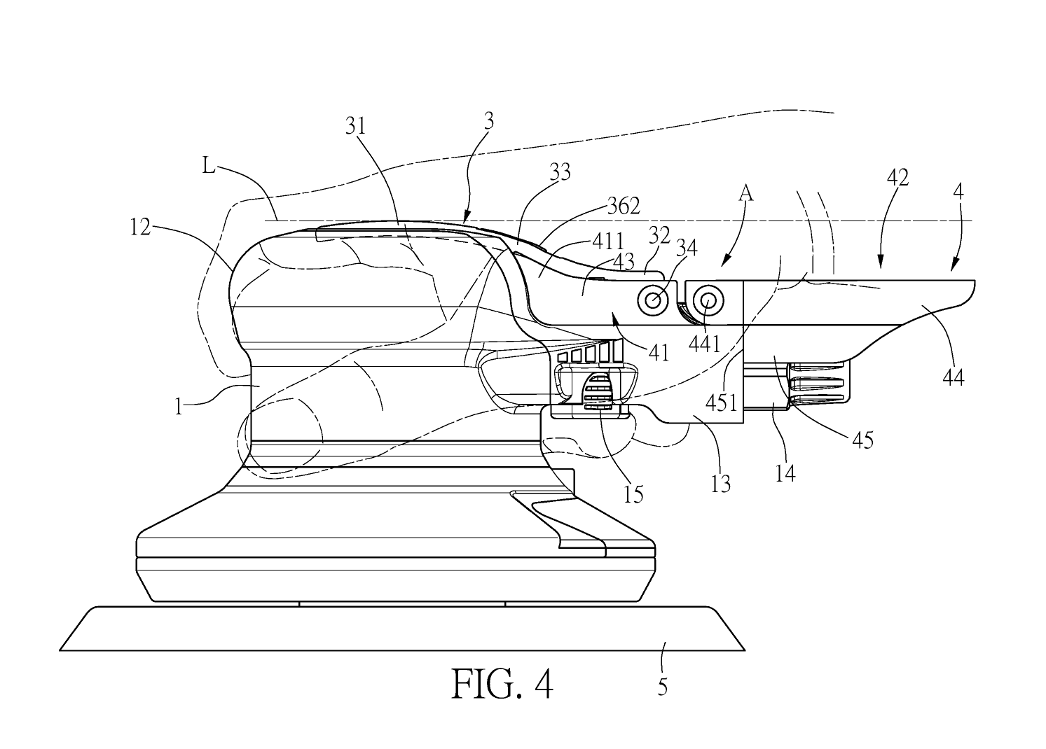

As shown in FIGS. 2 to 4, when the press handle 3 is pressed downward to the bottommost, a portion of the press handle 3 above the head portion 12 is defined as a front section 31 and another portion above the valve seat 13 is defined as a rear section 32. A bent section 33 is defined between the front section 31 and the rear section 32. The bent section 33 bends downward from the front section 31 to the rear section 32. The rear section 32 is connected to the tail portion 42 and is substantially flush with the tail portion 42. A depression A (as shown in FIG. 4) is formed above the bent section 33, the rear section 32 and the tail portion 42 relative to the height of the front section 31. When the operator grasps the head portion 12, the depression A allows the thenar and the hypothenar of the operator to move downward and lean against the cover 4. The location of the depression A for the bottom side of the wrist is significantly lower than the top end of the head portion 12. The top end of the head portion 12 includes a portion exposed out of the head portion 12 when the front section 31 of the press handle 3 is pressed downward to the bottommost.

As shown in FIGS. 2 to 4, the bent section 33 of the press handle 3 of the present invention is inclined. When the press handle 3 is pressed downward to the bottommost as described above, the side portion 41 is formed with an engaging portion 411 tilted upward corresponding to the inclination of the bent section 33. The bent section 33 is inclined in a curved manner. Therefore, the engaging portion 411 is tilted corresponding to the inclination of the bent section 33. However, in different embodiments, the bent section 33 may be non-inclined, for example, the bent section is bent at a right angle between the front section 31 and the rear section 32. In addition, in this embodiment, the rear section 32 of the press handle 3 is lower than the front section 31 by a height of 10 mm.

As shown in FIGS. 2 to 4, the cover 4 includes a front cover 43 and a rear cover 44. The front cover 43 and the rear cover 44 are separated. The side portion 41 is disposed on the front cover 43, and the tail portion 42 is disposed on the rear cover 44. The rear cover 44 of the cover 4 is pivotally connected to a top surface 131 of the valve seat 13 so that the cover 4 can be turned relative to the valve seat 13. The front cover 43 covers the valve seat 13. The front cover 43 may be removed from the valve seat 13. The arrangement of the cover 4 of the pneumatic angle grinder mainly covers the valve seat 13, with the tail portion 42 extending outward along the valve seat 13 to cover the connector 14 so that the connector 14 extending out of the valve seat 13 can be shielded. The tail portion 42 is configured to rest the operator's hand when the operator grasps the valve seat 13.

Two opposite sides of the tail portion 42 of the rear cover 44 have stop portions 45 extending in the direction of the connector 14. The stop portions 45 each have a side edge 451. When the rear cover 44 covers the valve seat 13, the side edge 451 abuts against one end of the valve seat 13, away from the head portion 12.

In the present invention, the press handle 3 is pivotally connected to the top surface 131 of the valve seat 13 through a shaft member 34. The valve seat 13 has a pair of ears 132 corresponding in position to the shaft member 34. The ears 132 have shaft holes 133 for insertion of the shaft member 34. The top surface 131 of the valve seat 13 has a groove 134 thereon. The ears 132 are located in the groove 134, such that the groove 134 allows the shaft holes 133 of the ears 132 to be further inclined downward relative to the top surface 131. The rear cover 44 is pivotally connected to the top surface 131 of the valve seat 13 through a shaft member 441. The valve seat 13 has a pair of ears 135 corresponding in position to the shaft member 441. The ears 135 have shaft holes 136 for insertion of the shaft member 441. The top surface 131 of the valve seat 13 has a groove 137 thereon. The ears 135 are located in the groove 137, such that the groove 137 allows the shaft holes 136 of the ears 135 to be further inclined downward relative to the top surface 131.

An inner ring 138 is provided in the valve seat 13 below the joint of the rear cover 44. The inner ring 138 is configured to receive the connector 14. The press handle 3 is pivotally connected to the top surface 131 of the valve seat 13 between the inner ring 138 and the switch 15. The ears 132 and the groove 134 where the corresponding shaft member 34 is inserted are also disposed between the inner ring 138 and the switch 15.

As shown in FIGS. 2 to 4, the bent section 33 the press handle 3 has an opening 35. A safety switch 36 is disposed in the opening 35 and pivotally connected to the press handle 3. The safety switch 36 is biased by a return spring 363. When the press handle 3 is not pressed downward and tilted upward, a bottom end 361 located below the press handle 3 is normally pressed against the top surface 131 of the valve seat 13. The safety switch 36 has a pull portion 362 exposed out of the press handle 3. When the pull portion 362 is pushed toward the opening 35, the bottom end 361 is moved away from the top surface 131 so that the press handle 3 can be pressed downward.

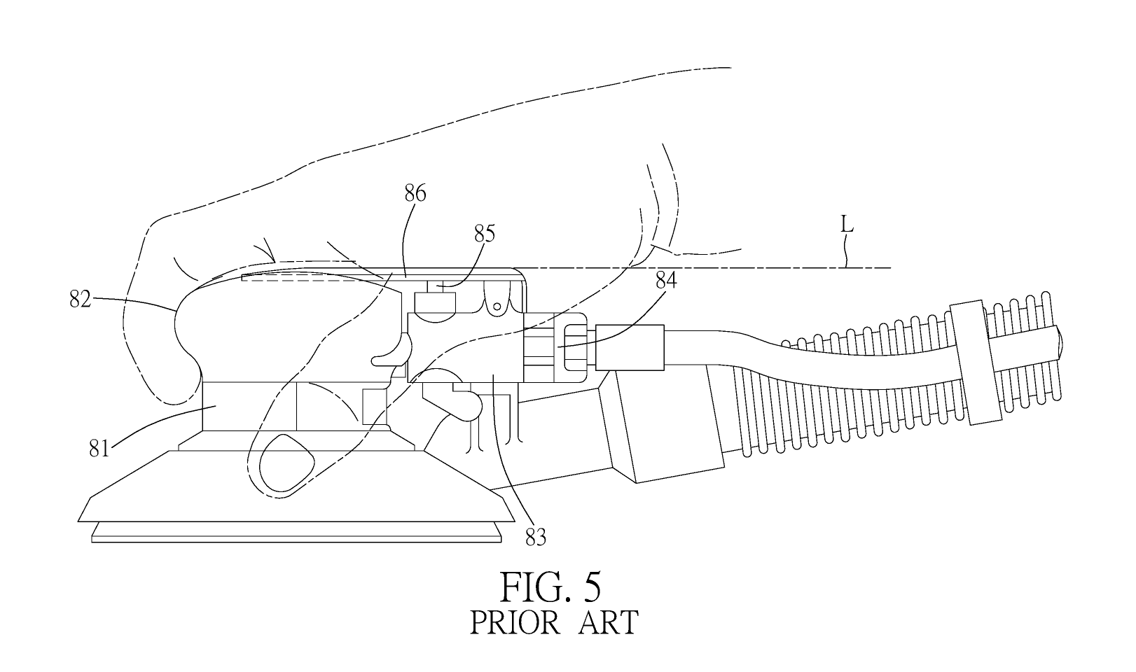

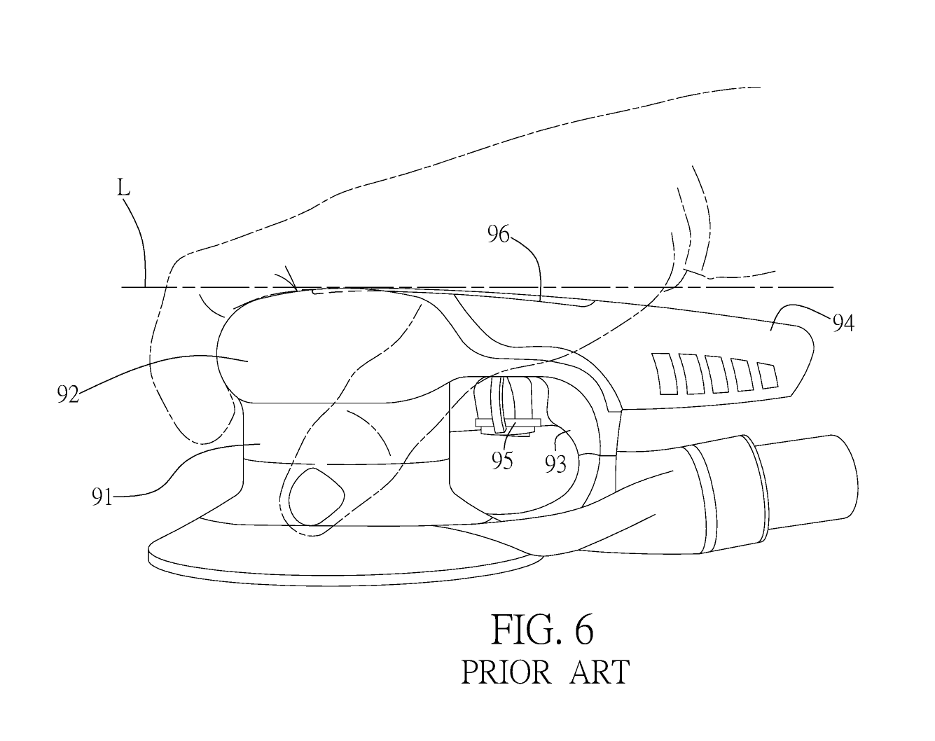

The top end of the head portion 82 of the conventional pneumatic angle grinder in FIG. 5 is drawn with a horizontal reference line L. When the operator grasps the head portion 82 of the main body 81, the bottom side of the wrist is significantly higher than the reference line L. As shown in FIG. 6, the top end of the head portion 92 is drawn with a horizontal reference line L. When the operator grasps the head portion 92 of the main body 91, the bottom side of the wrist is slightly lower than the reference line L. As shown in FIG. 4, the top end of the head portion 12 of the pneumatic angle grinder of the invention is drawn with a horizontal reference line L. When the operator grasps the head portion 12 of the main body 1, the bottom side of the wrist is much lower than the reference line L. It should be noted that the hand indicated by phantom lines in FIGS. 4, 5 and 6 is to illustrate the pneumatic angle grinder in accordance with the present invention and the prior art is actually grasped by the same hand.

In comparison with the distance between the wrist and the corresponding reference line in each of the aforesaid figures, the bottom side of the wrist shown in FIG. 5 is significantly higher than the top end of the head portion 82 of the main body 81 so that the wrist is significantly lifted. Although the bottom side of the wrist in FIG. 6 is slightly lower than the hand in FIG. 7, it is still higher than the top end of the head portion 92 of the main body 91, so the extent of the downward movement of the wrist is not obvious. On the contrary, as shown in FIG. 4, in the pneumatic angle grinder of the present invention, the extent that the bottom side of the wrist is lower than the reference line L is significant due to the depression A. Therefore, the aforementioned feature that the bottom side of the wrist is significantly lower than the top end of the head portion 12 allows the wrist to move downward significantly.

The advantage of the present invention is that when the operator uses the pneumatic angle grinder of the present invention, the head portion 12 of the main body 1 is held by the hand while the press handle 3 is pressed downward by the hand. When the press handle 3 is pressed downward to the bottommost, the rear section 32 is bent along with the bent section 33 so that the rear section 32 is lower than the front section 31. The depression A is formed above the bent section 33 and the rear section 32 of the press handle 3 and the tail portion 42 of the cover 4 relative to the height of the front section 31. Therefore, when the fingers hold the head portion 12 of the main body 1, the thenar and the hypothenar of the palm rest on the rear section 32 of the press handle 3 and the cover 4 (including the side portion 41 and the tail portion 42) at the depression A. Compared with the conventional pneumatic angle grinder, the position of the bottom side of the wrist is obviously lower than the top end of the head portion 12 so as to solve the problem that the posture is not ergonomic. Therefore, after a long-time use of the pneumatic angle grinder of the present invention, the hand holding the head portion 12 won't ache easily or have other discomforts.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A pneumatic angle grinder, comprising a main body, the main body having a passage therein for inhaling and exhausting air, high pressure air passing through the passage to drive an air motor to rotate so as to actuate a grinding device mounted to a bottom of the main body, the main body having a head portion at a top thereof and a valve seat extending from one side of the main body, the valve seat being provided with a connector for supplying air, the valve seat being provided with a switch for controlling rotation of the air motor, one end of a press handle being pivotally connected to the valve seat, the press handle extending beyond the switch, another end of the press handle being above the head portion, a cover being pivotally connected to the valve seat, the cover having a side portion located on the valve seat to cover opposite sides of the press handle, the cover having a tail portion extending outward along the valve seat to cover the connector, characterized in that:
when the press handle is pressed downward to the bottommost, a portion of the press handle above the head portion is defined as a front section and another portion above the valve seat is defined as a rear section, a bent section is defined between the front section and the rear section, the bent section bends downward from the front section to the rear section, the rear section is connected to the tail portion and is substantially flush with the tail portion, a depression is formed above the bent section, the rear section and the tail portion relative to a height of the front section, when an operator grasps the head portion, the depression allows the thenar and the hypothenar of the operator to move downward and lean against the cover, the bent section is inclined, the side portion is formed with an engaging portion tilted upward corresponding to the inclination of the bent section, the cover includes a front cover and a rear cover, the front cover and the rear cover are separated, the side portion is disposed on the front cover, the tail portion is disposed on the rear cover, the rear cover of the cover is pivotally connected to a top surface of the valve seat so that the rear cover can be turned relative to the valve seat, and the front cover covers the valve seat.

2. The pneumatic angle grinder as claimed in claim 1, wherein the bent section is inclined in a curved manner.

3. The pneumatic angle grinder as claimed in claim 1, wherein two opposite sides of the tail portion of the rear cover have stop portions extending in the direction of the connector, the stop portions each have a side edge, when the rear cover covers the valve seat, the side edge abuts against one end of the valve seat, away from the head portion.

4. The pneumatic angle grinder as claimed in claim 1, wherein each of the press handle and the rear cover is pivotally connected to the top surface of the valve seat through a shaft member, the valve seat has a pair of ears corresponding in position to the shaft member, the ears have shaft holes for insertion of the shaft member, the top surface of the valve seat has two grooves thereon, and the ears are located in the grooves.

5. The pneumatic angle grinder as claimed in claim 4, wherein an inner ring is provided in the valve seat below the joint of the rear cover, the inner ring is configured to receive the connector, the press handle is pivotally connected to the top surface of the valve seat between the inner ring and the switch, the ears and the groove where the corresponding shaft member is inserted are disposed between the inner ring and the switch.

6. The pneumatic angle grinder as claimed in claim 1, wherein the rear section is lower than the front section by a height of 10 mm.

7. The pneumatic angle grinder as claimed in claim 1, wherein the bent section of the press handle has an opening, a safety switch is disposed in the opening and pivotally connected to the press handle, the safety switch is biased by a return spring, when the press handle is not pressed downward and tilted upward, a bottom end located below the press handle is normally pressed against the top surface of the valve seat, the safety switch has a pull portion exposed out of the press handle, when the pull portion is pushed toward the opening, the bottom end is moved away from the top surface so that the press handle can be pressed downward.
